(19) United States
(12) Patent Application Publication
(10) Pub. No.: US 2009/0291873 A1
(43) Pub. Date: Nov. 26, 2009

(54) Method and Composition for Post-CMP Cleaning of Copper Interconnects Comprising Noble Metal Barrier Layers

(75) Inventor: Dnyanesh Chandrakant Tamboli, Breinigsville, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: Air Products and Chemicals, Inc., Allentown, PA (US)

(21) Appl. No.: 12/437,045

(22) Filed: May 7, 2009

Related U.S. Application Data
(60) Provisional application No. 61/055,288, filed on May 22, 2008.

(51) Int. Cl. C11D 7/32

(52) U.S. Cl. 510/175

(57) ABSTRACT

A composition and method comprising same for the post-chemical mechanical planarization (CMP) of substrates comprising copper and a noble metal, such as but not limited to, ruthenium is described herein wherein the composition controls and/or minimizes the corrosion of copper during the cleaning process. In one aspect, the composition comprises a compound comprising at least one group chosen from an amino acid group, a betaine group, and combinations thereof; optionally a pH modifier chosen from an organic acid, an organic base, or combinations thereof; optionally a surfactant; and optionally a chelating agent.

This Application claims the benefit of Provisional Application No. 61/055,288 filed on May 22, 2008, the disclosure of which is hereby incorporated by reference.

Disclosed herein are compositions for the post-chemical mechanical planarization (CMP) of substrates comprising copper and barrier layers comprising noble metals, such as but not limited to, ruthenium wherein the composition controls and/or minimizes the corrosion of copper during the cleaning process. Also disclosed are methods for controlling and/or minimizing the corrosion of copper in substrates further comprising a noble metal, by contacting the substrate with a composition comprising a compound comprising an amino acid group, a betaine group, or a combination thereof.

Semiconductor wafers contain copper interconnections which connect the active devices on the wafer with each other to form a functioning chip. The copper interconnects are formed by first forming trenches in the dielectric layer. A thin metallic barrier layer is typically deposited on the dielectric layer to prevent copper diffusion into the dielectric layer. This is typically followed by deposition of copper into the trenches. After the copper deposition, the wafer is polished using a process referred to as Chemical Mechanical Planarization (CMP). The CMP process removes excess copper deposits and planarizes the surface for a subsequent photolithographic step. In the CMP process, polishing and removal of excess material is accomplished through a combination of chemical and mechanical means. A typical CMP slurry is an aqueous suspension comprised of abrasive particles, reactive agents, surfactants, and a suitable oxidizing agent. Reactive agents that may added to slurries include organic acids (e.g. citric acid), amino acids (e.g., glycine) and azoles (e.g., benzotriazoles). Unfortunately, CMP processing leaves behind contaminants such as particles, films, metal ion impurities and oxides that are generated from the slurry or by the process itself. A post-CMP cleaning step is needed to remove the contaminants (e.g., residual particles, oxide layers, films, organic and inorganic residues, etc.) described above while limiting corrosion to the underlying substrate surface. In certain instances, the post-CMP cleaning step involves exposing the substrate to the post-CMP cleaning composition in, for example, a brush scrubber to remove the residues. The final step of the post-CMP cleaning process may be to rinse the substrate with copious amounts of water such as deionized (DI) water and then spin-drying the substrate.

During the cleaning process, there is a likelihood of corrosion of copper lines which may induced by the cleaning chemistry. For the interconnect technology modes of 32 nanometers (nm) and beyond, barrier layers are envisioned to consist of metals such as ruthenium. The choice of barrier metal may accelerate the corrosion lines through a mechanism known as “galvanic corrosion”. When a metallic piece is immersed in a solution, a electrochemical potential is developed at its interface with the solution. That potential is known as “open circuit potential (OCP)”. Metal with a higher open circuit potential is termed as more noble metal. Metals with lower potential are termed as more active metal. When two dissimilar metals are submerged in an electrolyte, while electrically connected, reactions occur at both metals in such a way that the potentials at the interfaces of the both metals are equal. In this process, the anodic processes which mostly comprise of corrosion/oxidation are accelerated on the the active metal, whereas the cathodic reactions are accelerated on noble metal. This results in higher corrosion on active metal, which is otherwise absent when it is not galvanically connected to the other metal. The rate of corrosion is determined by the electrolyte and the difference in nobility. The difference can be measured as a difference in voltage potential. Galvanic reaction is the principle which batteries are based on.

The performance of certain post-CMP cleaning compositions may be adversely effected if the substrate comprises a noble metal. Examples of noble metals include but are not limited to rhenium, ruthenium, rhodium, palladium, silver, osmium, iridium, platinum, and gold (i.e., the metals of groups VIIb, VIII, and Ib of the second and third transition series of the periodic table). The presence of the noble metal such as ruthenium in addition to copper in the substrate may create a potential problem of galvanic corrosion during the post-CMP cleaning step.

In a patterned wafer employing copper interconnects comprising noble barrier metals such as, but not limited to, ruthenium, the corrosion of copper is thereby accelerated through coupling with the relatively nobler barrier metal. The compositions described herein substantially reduce the extent of galvanic corrosion of copper in the presence of noble metal barriers such as ruthenium. These chemistries are very benign to copper in terms of corrosion when compared to other organic acid containing chemistries which do not contain an amino acid group, a betaine group, or a combination thereof. As a result, the corrosion issues in post-CMP cleaning are likely to be substantially reduced when the compositions described herein are used for cleaning.

A post-CMP cleaning composition and method comprising same for cleaning substrates comprising copper and a barrier layer comprising a noble metal, such as, for example, ruthenium are disclosed herein that remove contaminants generated from CMP cleaning and/or other processing steps while substantially controlling and/or minimizing corrosion of the copper contained within substrate due to galvanic corrosion. The term “contaminants” as used herein describes, but is not limited to, any abrasive particles, processing residues, reaction products of previous processing steps, cleaning compositions and components thereof, processing solutions and components thereof, oxides, metallic ions, salts, or complex, or combinations thereof which may be present within and/or upon the substrate as an oxide layer, film, and/or undesirable particles.

The post-CMP cleaning composition comprises: a compound comprising at least one group chosen from an amino acid group, a betaine group, and combinations thereof; water; optionally a solvent; optionally a pH modifier chosen from an organic acid, an organic base, or combinations thereof; optionally a surfactant; and optionally a chelating agent. Suitable pH values of the post-CMP cleaning composition include the following: about 2, about 3, about 4, about 5, about 6, about 7, about 8, about 9, about 10, and about 11 as well as any range or value between any two of these values, e.g., from about 2 to about 11. In certain embodiments, the pH range of the post-CMP cleaning composition may range from about 2 to about 11, or from about 3 to about 9, or from about 4 to about 8.

As mentioned previously, the post-CMP cleaning compositions comprise a compound comprising at least one chosen from an amino acid group, a betaine group, and combinations thereof. Examples of compounds with amino acid groups include but are not limited to glycine, alanine, lysteine, asparatic acid, glutamic acid, phenyl alaniene, hysidine, isoleucine, lycine, leucine, methionine, asparagine, praline, valine, serine, cysteine, and cystine. In certain embodiments, compounds which are derivatives of amino acids such as, for example, bicine and tricine may also be used. Examples of compounds with a betaine group include, but are not limited to, betaine, octyl betaine, coco-betaine, and N-dodecyl glycine betaine. In certain embodiments, the composition contains at least one compound comprising an amino acid group. In another embodiment, the composition comprises at least one compound comprising a betaine group. Suitable amounts of compound comprising at least one chosen from an amino acid group, a betaine group, and combinations thereof that is present in the composition include the following: about 10 parts per million (ppm), about 25 ppm, about 50 ppm about 75 ppm, about 100 ppm, about 150 ppm, about 200 ppm, about 250 ppm, about 300 ppm, about 400 ppm, about 450 ppm, about 500 ppm, about 750 ppm, about 1000 ppm, about 5000 ppm, about 1 weight percent (%), about 2 weight %, about 3 weight %, about 4 weight %, about 5 weight %, about 6 weight %, about 7 weight %, about 8 weight %, about 9 weight %, about 10 weight %, as well as any range or value between any two of these values, e.g., from about 10 ppm to about 10 weight %. In certain embodiments, the amount of compound comprising at least one chosen from an amino acid group, a betaine group, and combinations thereof that is present in the composition may range from about 10 ppm to about 10 weight %, or from about 100 ppm to about 1 weight %, or from about 100 ppm to about 1 weight %, or from about 1000 ppm to about 5000 ppm.

It is believed that compounds comprising at least one chosen from an amino acid group, a betaine group, and combinations thereof are most effective in controlling galvanic etching of copper in the pH range closer to their isoelectric point. However, in certain embodiments, it may be necessary to formulate the composition at a pH that is relatively more acidic or relatively more alkaline in order to meet other performance needs such as, but not limited to, particle removal efficiency, copper oxide dissolution, and/or inhibitor residue removal. In this embodiments, the composition may optionally include a pH modifier chosen from an organic acid, a base, and combinations thereof. Different acids that act as an acid pH adjustor such as monocarboxylic acids, dicarboxylic acids, hydroxycaboxylic acids, polyamino carboxylic acids may be added to lower the pH in acidic range. Exemplary acidic pH adjusters include acetic acid, phosphoric acid, and benzoic acid. In certain embodiments, the acidic pH adjuster may also be present in the composition as the corrosion inhibitor and/or chelating agent. Various basic pH adjustors such as ammonium hydroide, potassium hydroxide, guanidine carbonate, various amines, alcohol amines, or the like may also be used. Further basic pH adjustors include hydroxylamines, organic amines such as primary, secondary or tertiary aliphatic amines, alicyclic amines, aromatic amines and heterocyclic amines, aqueous ammonia, and lower alkyl quaternary ammonium hydroxides. Specific examples of the hydroxylamines include hydroxylamine (NH₂OH), N-methylhydroxylamine, N,N-dimethylhydroxylamine and N,N-diethylhydroxylamine. Specific examples of the primary aliphatic amines include monoethanolamine, ethylenediamine and 2-(2-aminoethylamino)ethanol. Specific examples of the secondary aliphatic amines include diethanolamine, N-methylaminoethanol, dipropylamine and 2-ethylaminoethanol. Specific examples of the tertiary aliphatic amines include dimethylaminoethanol and ethyldiethanolamine. Specific examples of the alicyclic amines include cyclohexylamine and dicyclohexylamine. Specific examples of the aromatic amines include benzylamine, dibenzylamine and N-methylbenzylamine. Specific examples of the heterocyclic amines include pyrrole, pyrrolidine, pyrrolidone, pyridine, morpholine, pyrazine, piperidine, N-hydroxyethylpiperidine, oxazole and thiazole. Specific examples of the lower alkyl quaternary ammonium salts include tetramethylammonium hydroxide (TMAH), tetraethylammonium hydroxide, tetrapropylammonium hydroxide, trimethylethylammonium hydroxide, (2-hydroxyethyl)trimethylammonium hydroxide, (2-hydroxyethyl)triethylammonium hydroxide, (2-hydroxyethyl)tripropylammonium hydroxide and (1-hydroxypropyl)trimethylammonium hydroxide. A combination of acids and bases may be used to achieve increased buffer capacity at the desired pH.

Surfactant may be optionally added to the composition. Any type of surfactant, such as anionic, cationic, non-ionic, and zwitterionic or combinations thereof, may be used. The choice of surfactant may depend upon various criteria including wetting properties, foaming properties, detergency, rinsability, etc. Further examples of surfactants include silicone surfactants, poly(alkylene oxide) surfactants, and fluorochemical surfactants. Suitable non-ionic surfactants for use in the process composition include, but are not limited to, octyl and nonyl phenol ethoxylates such as TRITON® X-114, X-102, X-45, X-15 and alcohol ethoxylates such as BRIJ® 56 (C₁₆H₃₃(OCH₂CH₂)₁₀₀H) (ICI), BRIJ® 58 (C₁₆H₃₃(OCH₂CH₂)₂₀OH) (ICI). Still further exemplary surfactants include acetylenic alcohols and derivatives thereof, acetylenic diols (non-ionic alkoxylated and/or self-emulsifiable acetylenic diol surfactants) and derivatives thereof, alcohol (primary and secondary) ethoxylates, amine ethoxylates, glucosides, glucamides, polyethylene glycols, poly(ethylene glycol-co-propylene glycol), or other surfactants provided in the reference McCutcheon's Emulsifiers and Detergents, North American Edition for the Year 2007 published by Manufacturers Confectioners Publishing Co. of Glen Rock, N.J. In embodiments where one or more surfactants are added, surfactant concentration may range from 1 ppm to 10000 ppm or from 50 ppm to 5000 ppm.

Corrosion inhibitors may also be optionally added to provide protection to the copper lines during the cleaning process. The compositions described herein can also optionally contain up to about 15% by weight, or about 0.2 to about 10% by weight of a corrosion inhibitor. Any corrosion inhibitor known in the art for similar applications, such as those disclosed in U.S. Pat. No. 5,417,877 which is incorporated herein by reference may be used. Examples of particular corrosion inhibitors include anthranilic acid, gallic acid, benzoic acid, isophthalic acid, fumaric acid, phthalic acid, maleic anhydride, phthalic anhydride, benzotriazole (BZT), 1,2,4 Triazole, amino-triazole, resorcinol, carboxybenzotriazole, and diethyl hydroxylamine and the like. Further examples of corrosion inhibitors that may be used include catechol, pyrogallol, and esters of gallic acid. Particular hydroxylamines that can be used include diethylhydroxylamine and the lactic acid and citric acid salts thereof. Yet other examples of suitable corrosion inhibitors include fructose, ammonium thiosulfate, glycine, lactic acid, tetramethylguanidine, iminodiacetic acid, and dimethylacetoacetamide. In certain embodiments, the corrosion inhibitor may include a weak acid having a pH ranging from about 4 to about 7. Examples of weak acids include trihydroxybenzene, dihydroxybenzene, and/or salicylhydroxamic acid.

The composition may also include one or more of the following additives: chemical modifiers, dyes, biocides, preservatives, dispersants, and other additives.

Water is present in the composition disclosed herein. It can be present incidentally as a component of other elements, such as for example, an aqueous based organic acid solution, an aqueous based organic base solution, and/or chelating solution, or it can be added separately. Some non-limiting examples of water include deionized water, ultra pure water, distilled water, doubly distilled water, or deionized water having a low metal content. Preferably, water is present in amounts of about 65% by weight or greater, or about 75% by weight or greater, or about 85% by weight or greater, or about 95% by weight or greater.

In certain embodiments, a solvent may be added to the composition in addition to, or in place of, water. In these embodiments, the non-aqueous solvent selected preferably does not react with other components in the composition or the substrate itself. Suitable solvents include, but are not limited to, hydrocarbons and derivatives thereof, including but not limited to, cyclic alkanes and acyclic alkanes (e.g. dodecane, hexane, pentane, hexadecane, cyclohexane, bicyclohexyl, tricyclohexane, decahydronapthalene, and cyclopentane; fluorinated (partially or fully) hydrocarbons and derivatives thereof (e.g., perfluorocyclohexane and perfluorodecalin); SF₅-functionalized hydrocarbons; halocarbons (e.g. Freon 113); ethers (e.g. ethylether (Et₂O), tetrahydrofuran (“THF”), ethylene glycol and derivatives thereof, monomethyl ether, or 2-methoxyethyl ether(diglyme)), and esters and derivatives thereof (e.g. sodium octanoate and sodium perfluorooctanoate). Still further exemplary solvents include lactates, pyruvates, and diols. These solvents include ketones such as, but are not limited to, acetone, ethyl acetate, cyclohexanone, acetone, N-methyl pyrrolidone (NMP), and methyl ethyl ketone. Other exemplary solvents include amides such as, but not limited to, dimethylformamide, dimethylacetamide, acetic acid anyhydride, propionic acid anhydride, and the like. Exemplary solvents can include, but are not limited to, sulfur-containing compounds such as mercaptans (e.g., lauryl mercaptan), sulfones (e.g., dimethyl sulfone, diphenyl sulfone, sulfoxides (e.g., dimethyl sulfoxide). Still further non-aqueous solvents include alcohols such as, for example, propylene glycol propyl ether (PGPE), methanol, tetrahydrofurfuryl alcohol, 1-methylcyclohexanol, cyclohexanol, 2-methylcyclohexanol, adamantemethanol, cyclopentanol, dimethyl-3-heptanol, dimethyl-4-heptanol, dodecanol, oleyl alcohol, pentanol, 1,5-pentanediol, 1,6-hexanediol, 1,4-butanediol, 1,2-propylene glycol, 1,3-propylene glycol, 1-dodecanol, cyclooctane, ethanol, 3-heptanol, 2-methyl-1-pentanol, 5-methyl-2-hexanol, cis-2-methylcyclohexanol, 3-hexanol, 2-heptanol, 2-hexanol, 2,3-dimethyl-3-pentanol, propylene glycol methyl ether acetate (PGMEA), ethylene glycol and derivatives thereof, polyethylene glycol and derivatives thereof, isopropyl alcohol (IPA), n-butyl ether, propylene glycol n-butyl ether (PGBE), 1-butoxy-2-propanol, 2-methyl-3-pentanol, 2-methoxyethyl acetate, 2-butoxyethanol, 2-ethoxyethyl acetoacetate, 1-pentanol, propylene glycol methyl ether, 3,6-dimethyl-3,6-octanol, maltose, sorbitol, mannitol, super, fully, and partially hydrolyzed poly(vinyl)alcohol, 1,3-butanediol, glycerol and derivatives thereof such as thioglycerol. Yet another non-aqueous solvent can be a silicone such as silicone oil. Still further non-aqueous solvents include 1,4-dioxane, 1,3-dioxolane, ethylene carbonate, propylene carbonate, ethylene carbonate, propylene carbonate, and m-cresol. The solvents enumerated above may be used alone, in combination with one or more other solvents, or in combination with water.

In an alternative embodiment, a concentrated composition comprising a compound comprising at least one group chosen from an amino acid group, a betaine group, and combinations thereof; water; optionally a solvent; optionally a pH modifier chosen from an organic acid, an organic base, or combinations thereof; optionally a surfactant; optionally a chelating agent; and optionally other additives is provided that may be diluted in water, a solvent, or a combination of water and solvent prior to use. A concentrated composition or “concentrate” allows one to dilute the concentrate to the desired strength and pH. A concentrate also permits longer shelf life and easier shipping and storage of the product.

The composition described herein may be prepared by mixing the ingredients together. The ingredients within the composition may be mixed together in any order. In certain embodiments, the ingredients used in cleaning composition described herein may be purified individually or as a composition consisting of two or more components using ion exchange methods to reduce trace metal ion contamination. In certain embodiments, the mixing may be done at a temperature range of about 40 to 60° C. to affect dissolution of the ingredients contained therein. In embodiments containing certain chelating acids such as EDTA, the solubility is very low in water. In these embodiments, it may thus be desirable to dissolve these acids in a solution containing the organic base first prior to adding the other components. The resulting composition may optionally be filtered to remove any undissolved particles that could potentially harm the substrate.

In certain embodiments, composition and method described herein is used to treat the surface of a substrate after the CMP step. Suitable substrates include, but are not limited to, semiconductor materials such as gallium arsenide (“GaAs”), boronitride (“BN”) silicon, and compositions containing silicon such as crystalline silicon, polysilicon, amorphous silicon, epitaxial silicon, silicon dioxide (“SiO₂”), silicon carbide (“SiC”), silicon oxycarbide (“SiOC”), silicon nitride (“SiN”), silicon carbonitride (“SiCN”), organosilica glasses (“OSG”), organofluorosilicate glasses (“OFSG”), fluorosilicate glasses (“FSG”), and other appropriate substrates or mixtures thereof. Substrates may further comprise a variety of layers to which the metal material such as copper, aluminum, tungsten, and tantalum is applied thereto such as, for example, diffusion barrier layers, antireflective coatings, photoresists, organic polymers, porous organic, inorganic materials, low dielectric constant materials, high dielectric constant materials, and additional metal layers. Further exemplary substrates include silicon, aluminum, or polymeric resins.

In certain embodiments, the substrate may contain copper or copper-containing materials. The terms “copper” and “copper-containing materials” are used interchangeably herein and includes, but is not limited to, substrates comprising layers of pure copper, copper-containing alloys such as Cu—Al alloys, and Ti/TiN/Cu, Ta/TaN/Cu, Ru/Cu and Ta/Ru/Cu multi-layer substrates.

Further, the composition may also chelate metal ions and clean various substrates such as, for example, semiconductor wafers after treatment with same.

The method described herein may be conducted by contacting a substrate having contaminants such as, for example, abrasive particles, processing residues, oxides, metallic ions, salts, or complex or combination thereof present as a film or particulate residue, with the described composition. The contacting step according to the method described herein can be carried out by any suitable means of contacting a substrate with a fluid known to those skilled in the art. The actual conditions, e.g. time, etc. depend on the nature and the amount of the contaminants to be removed. Most commonly the contaminants are cleaned by scrubbing the wafer in a brush cleaner. Typically, the brushes are made up of soft and porous poly-vinyl alcohol materials. The brushes may have different shapes depending upon the manufacturer of the processing tool. Most common shapes are rollers, discs and pencil brush. In addition or substitution to brush scrubbing alternate cleaning methods may also be used. The alternate cleaning methods could include for example, by immersion, RCA methods, application, spray, or via a single wafer process—either in batch or individual processes.

The method described herein may also include the step of drying the substrate. The drying step is carried out by any suitable means, for example, evaporation by applying heat or by centrifugal force, by flowing a dry inert gas over the substrate, spin-rinse-drying, isopropyl alcohol vapor drying, or by Maragoni drying. Drying is typically carried out under an inert atmosphere. In certain embodiments, a deionized water rinse or rinse containing deionized water with other additives may be employed before, during, and/or after contacting the substrate with the composition described herein.

The indefinite articles “a” and “an” as used herein mean one or more when applied to any feature in embodiments of the present invention described in the specification and claims. The use of “a” and “an” does not limit the meaning to a single feature unless such a limit is specifically stated. The definite article “the” preceding singular or plural nouns or noun phrases denotes a particular specified feature or particular specified features and may have a singular or plural connotation depending upon the context in which it is used. The adjective “any” means one, some, or all indiscriminately of whatever quantity. The term “and/or” placed between a first entity and a second entity means one of (1) the first entity, (2) the second entity, and (3) the first entity and the second entity.

Additional objects, advantages, and novel features of the composition and method comprised herein will become apparent to those skilled in the art upon examination of the following examples thereof, which are not intended to be limiting.

### EXAMPLES

In following examples, galvanic corrosion between copper and ruthenium is studied by immersing test wafer pieces of equal sizes in various compositions comprising different acids at certain molar concentrations provided in Table I and water. A copper piece is connected as the working electrode and the ruthenium piece is connected as the counter electrode of a Gamry potentiostat/galvanostat. The galvanic corrosion software for this electrochemical instrumentation allows the two wafer pieces to be electrically coupled for five minutes through the software controls. During this period in which copper and ruthenium pieces are electrically coupled, the galvanic current is recorded as a function of time. A total charge transferred can be calculated by integrating the current with time. Applying Faraday's law, the amount of copper dissolved within the cleaning compositons can be calculated using the Equation (1):

Amount etched(thickness)=(Charge transfer per unit area/96500)*(atomic weight/valency)/density (1)

TABLE I

| | | | Etch |
|---|---|---|---|
| | Functional group | Molar | rate |
| Name | description | Concentration | (A/min) |
| Malonic acid | Dicarboxylic acid | 0.0064M | 6.37 |
| Diethylene Triamine | Polyamino carboxylic | 0.0025M | 9.02 |
| Penta acetic acid | acid | | |
| Citric acid | Hydroxycarboxylic acid | 0.0035M | 5.18 |
| Citric acid | Hydroxycarboxylic acid | 0.005M | 5.84 |
| Oxalic Acid | Dicarboxylic acid | 0.005M | 5.14 |
| Oxalic Acid | Dicarboxylic acid | 0.0074M | 5.44 |
| Sulfamic acid | Amido sulfuric acid | 0.005M | 9.63 |
| DL-Alanine | Amino Acid | 0.005M | 0.09 |
| Glycine | Amino Acid | 0.005M | 0.10 |
| Betaine | Betaine | 0.005M | 0.02 |
| N,N-Dimethyl-N- | Betaine | 0.005M | 0.03 |
| dodecylglycine | | | |
| betaine | | | |
| Bicine | Amino acid derivative | 0.005M | 0.07 |

These results in Table I clearly show that the galvanic etch rate of copper with ruthenium is minimal when contacted with compositions comprising amino acid or betaine compounds.

### Example 2

In certain embodiments, a combination of acids may be required to achieve desired results. The present example shows the effect that pH adjustment has on the resultant etch rate of the composition. Exemplary compositions, containing various acids in a certain molar amount provided in Table 2, a pH adjuster added in an amount sufficient to reach the pH provided in Table 2, and water, are described in Table 2. The conditions were measured in the same method as Example 1. The pH of the composition was measured using a pH electrode and provided in Table 2. Table 2 shows that for certain compositions, the addition of an acidic pH adjustor lowered the galvanic etch rate of copper with ruthenium when compared to the addition of a basic pH adjustor.

TABLE 2

| | | | Etch rate |
|---|---|---|---|
| Acid | pH Adjustor | pH | (A/min) |
| 0.005 M Citric acid | Tetramethyl Amino hydroxide | 4 | 5.84 |
| 0.005 M Citric acid | Glycine | 3.94 | 2.56 |
| 0.005M Oxalic Acid | Tetramethyl Amino hydroxide | 3.98 | 5.14 |
| 0.005M Oxalic Acid | Glycine | 3.96 | 2.04 |

### Example 3

A patterned MIT 854 patterned wafer (supplied by Ramco Technologies) with copper lines and the following configuration: 10 kA electroplated copper/250 Å Ruthenium/50 Å Ta/3 kÅ Black Diamond™ (Trademark of Applied Materials Inc.) was polished with Cu3900 slurry obtained from DA Nanomaterials LLC. The wafer was polished for approximately 5 minutes and 30 seconds at a 2 pounds per square inch (psi) downforce with 120 revolutions per minute (RPM) platen rotation speed. The polishing resulted in copper lines embedded in a matrix of ruthenium. The wafer was then dried with a spin-rinse-drier, with a 60 second rinse time at low rotation speed and 120 second drying time at high rotation speeds.

Pieces of the wafers were exposed—to a cleaning composition described herein and designated Formulation 1 (e.g., 2.25 wt % Glycine, 0.6 wt % N,N-Dimethyl-N-dodecylglycine betaine (Empigen BB surfactant from Sigma Aldrich), and the balance of water) and a conventional post-CMP cleaning chemistry CP72B provided by Air Products and Chemicals Inc.—for 5 minutes at room temperature with stirring at approximately 300 RPM. Formulation 1 was diluted 60 times with water prior to testing. The pieces were examined using scanning electron microscopy (SEM) and atomic force microscopy (AFM) to evaluate the nature of corrosion which appears as etching and roughening of the copper surface.

SEM imaging was performed on Amray 3700 SEM at 10000× magnification.

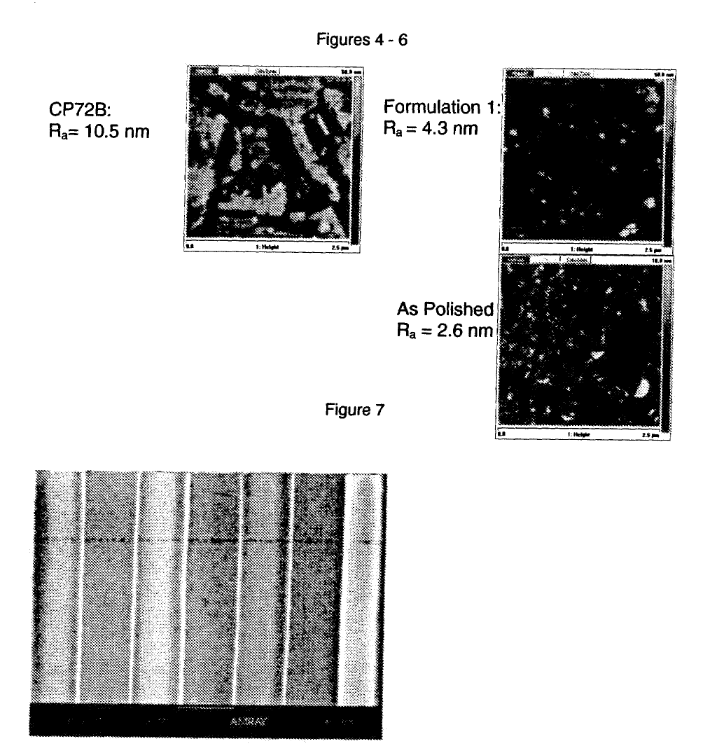

AFM measurements were performed with Digital Instruments Dimension 3000 with a Nanoscope IIIa controller. A scan area of 2.5 micron×2.5 micron was used for imaging. Route-mean-square surface roughness (Ra) in FIGS. 4-6 was calculated according to the Equation (2):

$$RMS = \sqrt{\frac{{\sum }_{i = 1}^{N} {( {Z}_{i} - {Z}_{ave} )}^{2}}{N}} \qquad ( 2 )$$

where Z_{avg} is the average Z value within the image; Zᵢ is the current value of Z; and N is the number of points in the image. This value is not corrected for tilt in the plane of the image; therefore, planefitting or flattening the data will change this value.

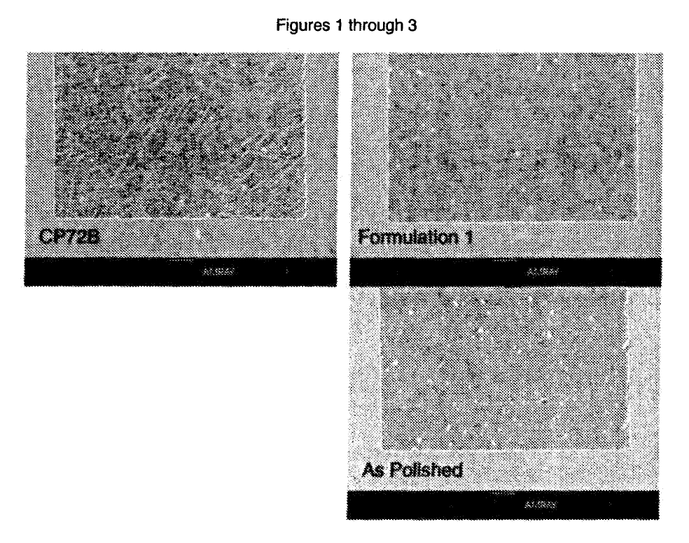

A comparison of the SEM (FIGS. 1-3) and AFM (FIGS. 4-6) digital images shows that the roughening is very low for Formulation 1 compared to the conventional post-CMP cleaning chemistry.

### Example 4

A MIT 854 patterned wafer (Provided by Ramco Technologies) with copper lines with the following configuration: 10 kA electroplated copper/250 Å Ruthenium/50 Å Ta/3 kÅ Black Diamond™ (Trademark of Applied Materials Inc.) was polished with Cu3900 slurry obtained from DA Nanomaterials LLC. The wafer was polished for approximately 5 minutes and 30 seconds at a 2 psi downforce with 120 RPM platen rotation speed. The polishing resulted in copper lines embedded in a matrix of ruthenium.

The wafer was then further polished using a commercial slurry targeted towards polishing ruthenium barrier layers. The wafer was then cleaned on Ontrak DSS-200 brush scrubbing tool.

In this example, the wafer was exposed to a cleaning composition described herein and designated Formulation 2 (1.5 wt % Glycine, 0.22 wt % N,N-Dimethyl-N-dodecylglycine betaine (Empigen BB surfactant from Sigma Aldrich), and the balance of water). Formulation 2 was diluted 60 times with water prior to testing. In brush box 1, the diluted chemistry was dispensed for 30 seconds followed by 30 seconds of DI water rinsing. In brush box 2, Formulation 2 was dispensed for 15 seconds followed by 45 seconds of cleaning. The wafers were dried using a spin-rinse drying process. FIG. 7 provides a SEM picture of copper lines after this cleaning process. The SEM picture clearly shows no evidence of corrosion.

1. A method for removing contaminants from a substrate after chemical mechanical planarization, the method comprising:
providing the substrate comprising copper, a noble metal, and contaminants;
contacting the substrate to a post-CMP cleaning composition comprising: a compound comprising at least one group chosen from an amino acid group, a betaine group, and combinations thereof; optionally a pH modifier chosen from an organic acid, an organic base, or combinations thereof; optionally a surfactant; and optionally a chelating agent to remove at least a portion of the contaminants; and
drying the substrate to provide a post-CMP treated substrate.

2. The method of claim 1 wherein the post-CMP treated substrate has a surface roughness of about 5.0 nanometers.

3. A composition for removing contaminants from a substrate comprising copper and a noble metal comprising:
a compound comprising at least one group chosen from an amino acid group, a betaine group, and combinations thereof;
optionally a pH modifier chosen from an organic acid, an organic base, or combinations thereof; and
optionally a surfactant.
